(19) United States
(12) Patent Application Publication
(10) Pub. No.: US 2011/0221622 A1
(43) Pub. Date: Sep. 15, 2011

(54) REMOTE CONTROL WITH USER IDENTIFICATION SENSOR

(76) Inventors: R. Michael Peters West, Colchester, VT (US); Robert Francis Shambro, Las Vegas, NV (US)

(21) Appl. No.: 12/984,545

(22) Filed: Jan. 4, 2011

Related U.S. Application Data
(60) Provisional application No. 61/312,444, filed on Mar. 10, 2010.

(51) Int. Cl. H04L 17/02

(52) U.S. Cl. 341/176

(57) ABSTRACT

Described herein is a remote control including a saucer-shaped housing, a removable faceplate, and a processor. The saucer-shaped housing may be circular in plan view and sized to be graspable by a user in one or two hands. The upper side of the housing may be convexly shaped and support a keypad with a plurality of selectable buttons. In some embodiments, the remote control includes a biometric sensor for receiving biometric information from a user of the remote control and communicating the received biometric information to a processor configured to recognize the user based on the received biometric information. The remote control and/or the processor may be configured to enable a recognized user to access viewing control options provided via the hand-held remote control device.

### RELATED APPLICATIONS

This application claims priority to and incorporates by reference U.S. Provisional Patent Application 61/312,444 filed 10 Mar. 2010.

### FIELD OF THE INVENTION

The present invention relates to a remote control with one or more sensors for determining user identity.

### BACKGROUND

Conventional remote controls for electronic devices such as televisions, set-top boxes, and computers may be used by anyone who picks them up and, in this way, any user of a remote control has the same experience with the remote control and/or device he or she is remotely controlling. Thus, conventional remote controls do not offer various security and customization options that may be desirable to a user.

Additionally, conventional remote controls only provide control buttons such as command keys (e.g., input selection, play, and fast forward) and toggling or arrow keys that allow a user to navigate through an interface, such as a graphic user interface (GUI) displayed on a television. Interaction with the GUI in this manner is awkward and often times requires a user to make multiple selections in order to execute a simple command.

### SUMMARY

Described herein is a hand-held remote control device including a saucer-shaped housing, a removable faceplate, and a processor. The saucer-shaped housing may be circular in plan view and sized to be graspable by a user in one or two hands. The upper side of the housing may be convexly shaped and support a keypad with a plurality of selectable buttons. The lower side of the housing may be partially convexly shaped and include a depression. The depression may be sized and adapted to accommodate one or more fingers of one or both hands of a user, such that when the housing is held by the user in two hands, at least some fingers of the user's hand(s) are disposed within the depression on the partially lower convex side of the housing and thumbs of the user's hands are located in proximity to the selectable buttons of the keypad such that a user may select the button(s) with his or her thumbs. The faceplate may be removably attached to the housing and adapted to maintain the keypad in contact with a portion of a surface of the upper side of the housing. The processor may be communicatively coupled to receive command inputs responsive to selection of one or more of the selectable buttons of the keypad and to communicate instructions to a communication interface communicatively coupled to the processor.

In one embodiment, the hand-held remote control may also include a keypad membrane removably attached to the housing and positioned beneath the faceplate. The keypad membrane may include, for example, keys, buttons, soft buttons, trackpads, touchscreens, and/or mouse buttons that extend upward from the keypad membrane through openings in the faceplate and may be selectable by a user when the user applies pressure to, or otherwise selects, one or more of the exemplary keys, buttons, soft buttons, trackpads, touchscreens, and/or mouse buttons. On some occasions, the keypad membrane may further include an identification mechanism, such as an ID tag, a bar code, a radio frequency identifier (RFID), and/or a microchip in order that the processor and/or other means within the hand-held remote control device and/or the communication interface may be configured to recognize the keypad membrane via the identification mechanism.

The communication interface may be configured to respond to the instructions by transmitting one or more signals to an external device and receive a set of instructions from an external source. On some occasions, the communication interface may include a transceiver configured to wirelessly communicate with an external device via an electromagnetic signal, a 2.4 gigahertz radio frequency signal, an infrared signal, a Bluetooth signal, a ZigBee signal, a radio frequency for consumer electronics (RF4CE) signal, and/or a benign microwave signal. In some cases, the communication interface may include a port compatible with, for example, a universal serial bus (USB) cable, a micro USB cable, a firewire cable, and/or an Ethernet cable.

In some embodiments, the hand-held remote control device may further include a biometric sensor coupled to the processor and/or other means within the hand-held remote control device and configured to receive biometric information from a user of the hand-held remote control device and communicate the received biometric information to the processor. In this embodiment, the processor may be further configured to recognize the user based on the received biometric information and enable a recognized user viewing control options provided via the hand-held remote control device. Exemplary biometric sensors include optical scanners, fingerprint scanners, retinal scanners, face recognition scanners, DNA scanners, voice scanners, electromagnetic signal receivers, means for electrical measurement, and microphones. In some cases, the hand-held remote control device is further configured to communicate the received biometric information to a set-top box and receive verification of a user's identity via the set-top box.

Some embodiments of the hand-held remote control device may include a rechargeable power source configured to recharge via a coupling with a power source provided in a docking station and/or a port configured to exchange information with the docking station and/or a cable that connects to a means capable of providing such power and/or such information exchange.

Other embodiments of the hand-held remote control device include a memory configured to store one or more sets of instructions executable by the processor and receive one or more sets of instructions via the communication interface and/or the port. In one case, the hand-held remote control device includes one or more motion sensors configured to detect motion of the hand-held remote control device in one or more directions.

Exemplary systems disclosed herein include a hand-held remote control device, a set-top box and a display device. The hand-held remote control device may be similar to the one described above and may include a saucer-shaped housing, a removable faceplate, a removable keypad, and a processor. The saucer-shaped housing may be circular in plan view and sized to be graspable by a user in one or two hands. The upper side of the housing may be convexly shaped and support a keypad with a plurality of selectable buttons. The lower side of the housing may be partially convexly shaped and include a depression. The depression may be sized and adapted to accommodate one or more fingers of one or both hands of a user, such that when the housing is held by the user in two hands, at least some fingers of the user's hand(s) are disposed within the depression on the partially lower convex side of the housing and thumbs of the user's hands are located in proximity to the selectable buttons of the keypad such that a user may select the button(s) with his or her thumbs. The faceplate may be removably attached to the housing and adapted to maintain the keypad in contact with a portion of a surface of the upper side of the housing.

The processor of the hand-held remote control device may be communicatively coupled to receive command inputs responsive to selection of one or more of the selectable buttons of the keypad and to communicate instructions to a communication interface communicatively coupled to the processor. The communication interface may be configured to respond to the instructions by transmitting one or more signals to an external device and receive a set of instructions from an external source. On some occasions, the communication interface may include a transceiver configured to wirelessly communicate, for example, uni-directionally or bi-directionally, with an external device via, for example, an electromagnetic signal, a 2.4 gigahertz radio frequency signal, an infrared signal, a Bluetooth signal, a ZigBee signal, a radio frequency for consumer electronics (RF4CE) signal, and a benign microwave signal. In some cases, the communication interface may include a port compatible with, for example, a universal serial bus (USB) cable, a micro USB cable, a firewire cable, and an Ethernet cable.

The set-top box of the system may be adapted to receive signals from the communication interface of the hand-held remote control device and/or configured to provide information for display to the user on a display device. The display device may be communicatively coupled to the set-top box and configured to display the information provided by the set-top box to the user. Exemplary display devices include televisions, monitors, and touchscreens.

On some occasions, the hand-held remote control device of the system may further include a biometric sensor coupled to the processor and configured to receive biometric information from a user of the hand-held remote control device, recognize the user based on the received biometric information, enable a recognized user to control viewing options provided to the recognized user via the set-top box, and/or enable the recognized user to customize at least one of a function associated with the hand-held remote control device (e.g., generate or modify a shortcut key) and information available for display to the user via the set-top box.

In some embodiments, the system may further include a server communicatively coupled to receive biometric information regarding the user of the hand-held remote control device via the hand-held remote control device and/or the set-top box, analyze the received biometric information in order to verify the user's identity, and/or communicate verification of the user's identity to the at least one of the hand-held remote control device and the set-top box. In other embodiments, the hand-held remote control device may be configured to provide user-customized viewing control options upon receipt of verification of the user's identity.

### BRIEF DESCRIPTION OF THE DRAWINGS

The present invention is illustrated by way of example, and not limitation, in the figures of the accompanying drawings, in which:

FIG. 1 illustrates an example of a network configured in accordance with an embodiment of the invention for delivering television content over the Internet;

FIG. 2 illustrates an example of a set-top box configured for use in a network such as that depicted in FIG. 1;

FIGS. 3 and 4 illustrate examples of a remote control having a sensor for determining user identity in accordance with an embodiment of the present invention;

FIGS. 5-11 illustrate examples of a remote control with a saucer-shaped housing in accordance with an embodiment of the present invention;

FIG. 12A illustrates an example of a remote control having a keyboard and removable faceplate arrangement in accordance with an embodiment of the present invention;

FIG. 12B illustrates an alternative example of a remote control having an keyboard and removable faceplate arrangement in accordance with an embodiment of the present invention;

FIG. 13A illustrates an exploded view of a remote control having a removable faceplate in accordance with an embodiment of the present invention;

FIG. 13B illustrates a side view of a remote control having a removable faceplate in accordance with an embodiment of the present invention; and

FIG. 14 illustrates a remote control positioned within an exemplary docking station in accordance with an embodiment of the present invention.

### DETAILED DESCRIPTION

Described herein is a remote control with one or more sensors for determining user identity. The present remote control has a variety of applications and finds particular use in conjunction with set-top boxes for delivering television programming and/or other content via the Internet or other computer-based networks or via conventional cable (i.e., hybrid fiber coax) or satellite television networks. In one embodiment, the present remote control is fitted with one or more sensors that can aid in determining user identity (e.g., as determined based on biometric readings provided via the sensor(s)). Such remote controls can be especially useful in enforcing parental control preferences, or in accessing user-defined interface elements such as customized electronic program guides (EPGs).

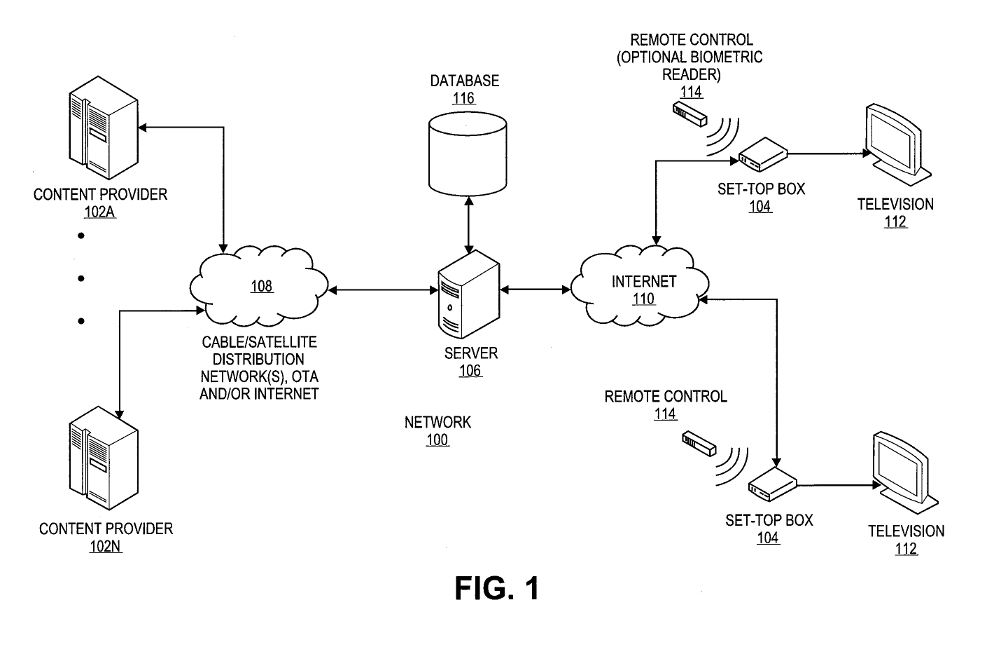

Referring first to FIG. 1, an example of a network 100 configured for delivery of television content via the Internet or other computer-based network in accordance with embodiments of the invention is shown. As indicated above, however, the present invention is equally applicable to other television content delivery means, including cable and/or satellite distribution means, and so the following description is intended only as an example of the environment within which the methods and systems that comprise the invention may be implemented. The television or other content (e.g., Internet content, gaming content, music content, or radio content) is delivered from various service providers 102A-102N, preferably on a user-defined, á la carte basis, to one or more subscribers, each equipped with a set-top box 104 or other mechanism capable of executing the functions of set-top box 104. That is, subscribers to an Internet-delivered television service are each able select their own service offerings, i.e., each subscriber may select his/her own set of television channels instead of having to select prepackaged channel/content offerings designed by a cable, satellite or other service provider. In this way, the subscribers may choose any number of television channels, in any combination, and pay subscription fees solely according to their selections.

This á la carte service offering is made possible by collecting or channeling the television content from the many service providers 102A-102N at/through a server 106 (note, although only one server 106 is illustrated, it should be appreciated that this one server may represent many servers, arranged in a central or distributed fashion, in order to accommodate a large subscriber base—for example, such servers may be organized as a central cloud and/or may be distributed geographically or logically to edges of a network in order to minimize service latencies; in either instance, various content may be replicated across the servers that make up the distribution network). Server 106 may receive the content via any of a number of means 108, including conventional cable or satellite television distribution means, over-the-air broadcast, or via one or more computer-based networks, such as the Internet. The content is delivered from server 106 to the various set-top boxes 104 via the Internet 110. Server 106 stores this content (either itself or in attached storage) and may distribute the content for retention on/by other servers within the network. The content is retained for a period of time (which may vary depending on the content, the content providers' wishes, the available storage space, the popularity of the content, etc.) allowing such stored content to be accessed by subscribers at a later time. In this way, the network may operate as an on-line digital video recorder. The television content includes television programming (e.g., both stored and live programming), Internet-based content (including subscriber-generated content), and metadata that include information about the programming and other content (including, but not limited to, episode names, dates and times of broadcast, etc.).

Each set-top box is communicatively coupled to server 106 (e.g., via a local area network (LAN) using either a wired or wireless connection to a modem or similar equipment that couples the LAN to the Internet in order to exchange data therewith, and, in turn, delivers the content to an associated display device, television, or monitor 112 that is communicatively connected to the set-top box (e.g., via a wired or a wireless connection). Individual channel selection may be made via a wireless remote control 114 that is communicatively coupled to a respective set-top box. Selection may be via the electronic program guides discussed below, and/or via hard buttons or other user-manipulable selectors (rocker switches, touch screens, etc.) present on the remote control. The remote control may optionally be fitted with a biometric reader, such as a fingerprint reader, for use in identifying the user holding or operating the remote control. The use of biometric readings facilitated by such devices allows for the generation and presentation of customized electronic program guides (EPG) for the user. Of course, user identity may be established in other ways, for example using a log-in process and/or using other biometric readings taken by sensors associated with the remote control and/or the set-top box 104 (or even a separate computer system or appliance communicatively coupled to the set-top box 104).

Server 106 is also communicatively coupled to a database or other storage means 116. This database may be used to store subscriber information, such as subscriber profiles, subscriber channel selections, subscriber-customized EPG preferences, copies of television content (for on-demand viewing, etc.), and other information. As noted above, server 106 (in some cases, together with other servers and associated data storage devices, such as database 116) retains content for a period of time, allowing it to be accessed by subscribers in an on-demand or time-shifted fashion. The subscriber channel selection information may include information regarding current channels subscribed to by a subscriber, gifted channels provided to others by a subscriber, one-time channel subscriptions for on-demand viewing, etc.

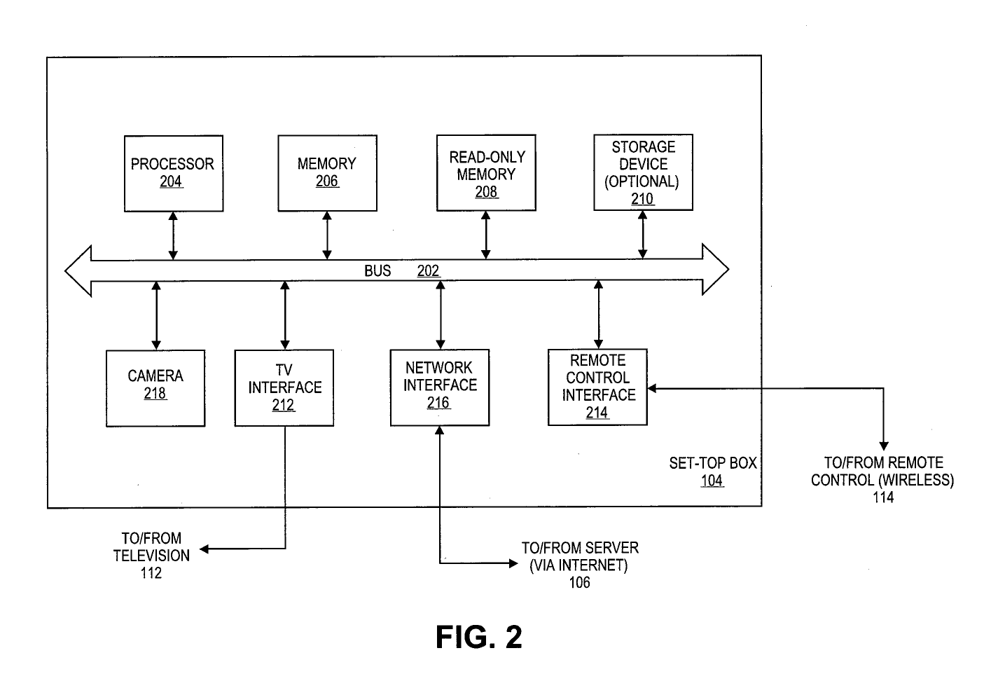

FIG. 2 illustrates features of a set-top box 104 in greater detail. Note that the depicted set-top box 104 is intended only as an example of a set-top box configuration and is not intended to limit the scope of the present invention in any way. Many of the features and functions provided by the elements described below could be integrated on a single system-on-a-chip or could be distributed over more or fewer modules that are discussed herein. In some cases the functions and features of the set-top box would be integrated into another device, for example the display device as in the case of an Internet-enabled television. Therefore, the precise hardware configuration of the set-top box and the precise location of the functions and features attributed to said set-top box are not critical to the present invention.

In the illustrated example, set-top box 104 includes a bus 202 or other communication mechanism for communicating information, and a processor 204 coupled with the bus 202 for processing information. The set-top box also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204.

Set-top box 104 further includes a read only memory (ROM) 208 or other static storage device coupled to the bus 202 for storing static information and instructions for the processor 204. An optional storage device 210, such as a magnetic disk or flash memory, may be provided and coupled to the bus 202 for storing (at least temporarily) television and/or EPG content and instructions (e.g., the operating system for the set-top box, user EPG preferences, etc.). If present, storage device 210 (which may, in some instances, be an external storage device or a combination of an internal and an external storage device) may facilitate the use of the set-top box as a digital video recorder (DVR).

According to one embodiment of the invention, the processor 204 (or other application specific hardware) executes sequences of instructions contained in main memory 206 in order to decode (or encode) the audio/video content for presentation via television 112 and produce the customized on-screen EPGs that may be overlaid or otherwise presented via television 112. Such instructions may be read into main memory 206 from another computer-readable medium, such as storage device 210 or ROM 208. In alternative embodiments, hard-wired circuitry may be used in place of, or in combination with, computer software instructions to implement the invention. Thus, embodiments of the invention are not limited to any specific combination of hardware circuitry and software.

Set-top box 104 may be coupled to television 112 via a television interface 212. Television interface may correspond to any of a number of conventional interfaces such as a high definition multimedia interface (HDMI) or other interface. An input device, such as the remote control 114, is communicatively coupled to the bus 202 for communicating information and command selections to the processor 204 via a remote control interface 214. Such an interface may be an infrared (IR) or other interface. The input device should be configured to permit manipulation of an on-screen cursor along at least two axes, e.g., a first axis (e.g., x) and a second axis (e.g., y), allowing the device to specify positions in a two-dimensional plane.

Set-top box 104 also includes a network interface 216 coupled to the bus 202. Network interface 216 provides a two-way data communication path with server 106. For example, network interface 216 may be a wired or wireless local area network (LAN) interface to provide a data communication connection to a compatible LAN (such as a LAN that uses an IEEE 802.11a/b/g/n communication protocol). Set-top box 104 can send messages and receive data, including television content and EPG information, firmware updates, and other information through network interface 216.

Optionally, set-top box 104 may also include a camera 218 coupled to the bus 202. Camera 218 may take a photograph of one or more users. In some embodiments, a photograph taken by camera 218 may be used by, for example, set-top box 104, server 106, and/or means 108 to verify the user's identity.

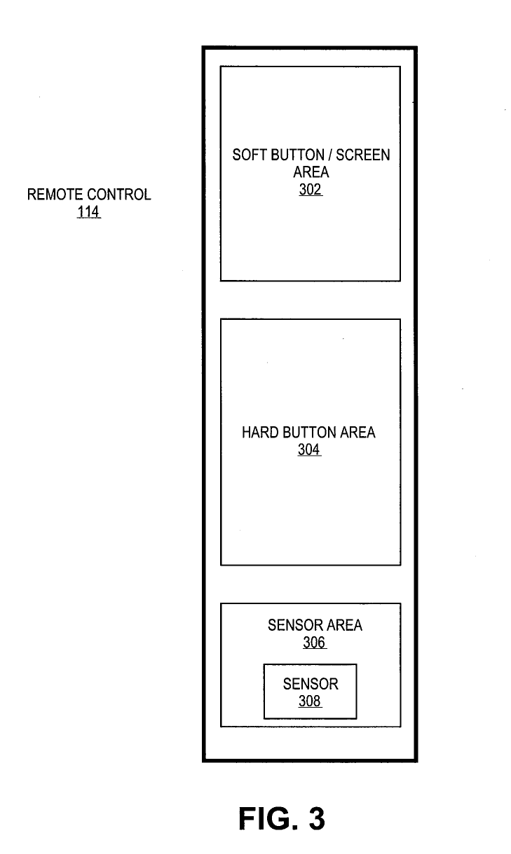

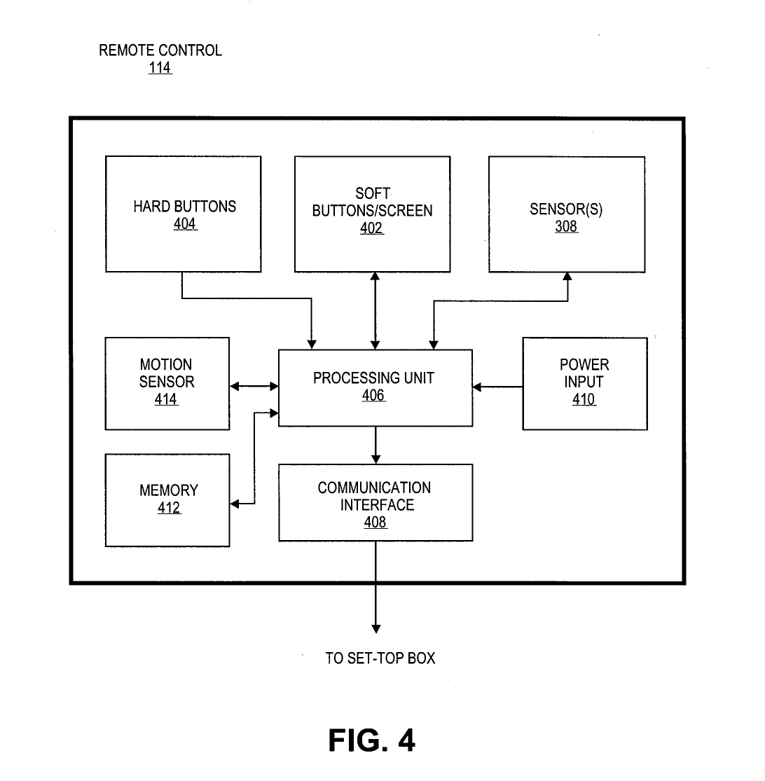

Referring now to FIGS. 3 and 4, an example of a remote control 114 having one or more sensors for determining user identity is shown. Remote control 114 includes a soft button/screen area 302, a hard button area 304 and a sensor area 306, within which one or more sensors 308 may be located. Note that the division of these areas on the remote control is being shown merely for purposes of illustration and the actual layout of components, buttons, screens and sensors may vary according to ergonomic and other considerations.

Optional soft button/screen area 302 may include one or more screens (e.g., liquid crystal display screens) for implementing soft (e.g., programmable) buttons 402 and/or providing messages to a user. In some embodiments, soft button/screen area 302 may be a touchscreen or a trackpad (e.g., capacitive touchscreen) and may be responsive to a user's touch and/or gesture. Optional hard button area 304 may include one or more hard buttons 404, such as alphanumeric keys, slider switches, rocker switches, and the like. Sensor area 306 includes one or more sensors 308, which may be configured to obtain or record biometric information from a user. For example, fingerprint sensors may be configured to obtain fingerprint information regarding a user when a finger is swiped across or placed over an input interface. Exemplary sensors 308 include optical scanners, electromagnetic signal receivers, and microphones. In some embodiments sensor 308 may be a biometric sensor, such as, a fingerprint scanner, a retinal scanner, a face recognition scanner, a DNA scanner, and/or a voice scanner.

The processing unit(s) 406 (which may include a processor and a memory) may provide matching functionality and may be included in the remote control (as shown in FIG. 4) and/or may be included in the set-top box 104. In the former instance, the remote control may be responsible for determining the identity of the user (i.e., the person operating the remote control) and passing that information or an indication that the user was authorized to perform certain functions to the set-top box 104. In the latter case, the remote control may simply pass the raw or processed data gathered by the sensor and the set-top box 104 may be responsible for determining the user's identity or set-top box 104 may pass the raw or unprocessed data to another device coupled to the set-top box 104 (e.g., server 106) via, for example, the Internet and the other device may be responsible for determining the user's identity. In each instance, identity would be determined based on a comparison of the data obtained by the sensor with some previously stored data obtained in a similar fashion.

On some occasions, processing unit 406 may include a clock or counter configured to determine the length of a period of inactivity for remote control 114. When a period of inactivity extends past a threshold period of time (e.g., 30 or 60 seconds), processing unit 406 may initiate a power saving, or sleep, mode of operation for remote control 114. For example, when remote control 114 has been inactive for a threshold period of time, remote control 114 may enter a power saving sleep mode during which only certain functions receive power. Remote control 114 may exit the power saving sleep mode upon activation of a remote control function by, for example, a user and/or set-top box 104. In this way, processing unit 406 and the clock and/or counter may act as a power management system for remote control 114.

The remote control 114 also includes a communication interface 406 (typically a wireless interface such as an infra-red interface or a radio frequency signal interface) to pass instructions and information to the set-top box. In some instances, communication interface 408 may include a transceiver configured to communicate, for example, uni-directionally, or bi-directionally with an external device, such as set-top box 104, via, for example, communication port 705, an electromagnetic signal, a 2.4 gigahertz radio frequency signal, an infrared signal, a Bluetooth signal, a ZigBee signal, a radio frequency for consumer electronics' (RF4CE) signal, and/or a benign microwave signal. Optionally, communication interface may include a communication port compatible with, for example, a universal serial bus (USB) cable, a micro USB cable, a fire wire cable, an Ethernet cable, and the like. A user of remote control 114 and/or communication interface 408 may be enabled to interact with set-top box 104 via, for example, a command line interface (CLI) and/or a graphic user interface (GUI) displayed on the display device 112.

In some instances, the sensors 308 may be included within the body of the remote control 114, which may have a transparent or translucent housing (e.g., the housing may be made of a material that is opaque to visible light but transparent or translucent to non-visible light (or electromagnetic energy) such as infra-red light, ultra-violet light or benign microwaves). In this way, biometric readings may be taken through the body of the remote control 114. In addition to or in place of fingerprint scanners, the biometric sensors employed by the remote control may include retinal scanners, face recognition scanners, DNA scanners, or other forms of biometric scanners. Further, other sensing means including those capable of detecting sound energy, such as ultra-sound and voice, may be employed to detect identifiable characteristics of the user.

The use of biometric scanners may allow for control over the viewing options provided to the user via the set-top box 104. For example, the order of channels in a channel line-up for an EPG may be specified according to user identity. Alternatively, or in addition, the availability of channels may be determined by user identity, (i.e., based on biometric readings from the biometric sensor included in the remote control). For example if a fingerprint scanner is included in the remote control, the user may be identified via a fingerprint scan and a channel line-up according to that user's preferences may be presented. This may also be used in combination with parental controls so that if the biometric reading is associated with a minor or other identifiable user (e.g., based on a pre-established profile), only a predetermined list of channels (which may exclude channels deemed to be unsuitable for the identified user) may be presented in the channel line-up. In addition to channel line-ups and accessibility, other user account features, such as message in-boxes, account payment/status information, or other features may be made accessible or not according to the user identity determined using the remote control.

Understanding the user identity also assists in creating customized channel line-ups. Knowing the user identity, it is possible for the set-top box 104 or the server 106 (if the identity information is passed from the set-top box 104 to the server 106) to associate viewing statistics with the user and develop custom playlists and/or channel line-ups based on that monitored information.

Remote control 114 may further include a power supply 410 such as, a battery or a rechargeable battery. On some occasions power supply 410 may be rechargeable and may be configured to recharge via a coupling with a power source provided in, for example, a docking station.

Optionally, remote control 114 includes a memory 412. Memory 412 may be any appropriate data storage device such as read only memory (ROM), flash memory, optical media, magnetic media, and random access memory (RAM). Memory 412 may be configured to store one or more sets of instructions executable by processing unit 406 and receive one or more sets of instructions, such as firmware updates, via communication interface 408.

On some occasions, remote-control 114 may include one or more motion sensors 414 configured to detect motion of the hand-held device in one or more directions. Exemplary motion sensors 414 include accelerometers and gyroscopes. Motion sensors 414 may be used to support a user's interaction with a GUI displayed on display device 112 in the manner of an “air mouse.” On some occasions, the one or more motion sensors 414 may transmit a message to processing unit 406 indicating that motion of remote control 114 has been detected. On other occasions, processing unit 406 may scan the one or more motion sensors 414 in order to determine whether the one or more motion sensors 414 has detected, or sensed, any motion of remote control 114.

In one embodiment, one or more motion sensors 414 may act in conjunction with, for example, processing unit 406 and/or a clock or counter included in processing unit 406 in order to determine the length of a period of immobility for remote control 114. When a period of immobility, as detected by the one or more motion sensors 414, extends past a threshold period of time (e.g., 30 or 60 seconds), processing unit 406 may initiate a power saving, or sleep, mode of operation for remote control 114. In this way, processing unit 406, the clock, counter, and/or one or more motion sensors 414 may act as a power management system. For example, when remote control 114 has been immobile for a threshold period of time, remote control 114 may enter a power saving, or sleep, mode during which only certain functions receive power. On some occasions, after remote control 114 enters power saving, or sleep, mode, the frequency with which processing unit 406 scans the one or more motion sensors 414 may decrease in order to further reduce power consumption. Remote control 114 may exit the power saving sleep mode upon a detection of movement by at least one of the motion sensors 414 and/or activation of a remote control function by, for example, a user and/or set-top box 104. Alternatively the motion sensor(s) could be configured to provide an interrupt to the processor and/or the attached circuitry, and hence the entire remote control, when motion is detected causing the remote control to exit the power saving sleep mode and return to the active mode.

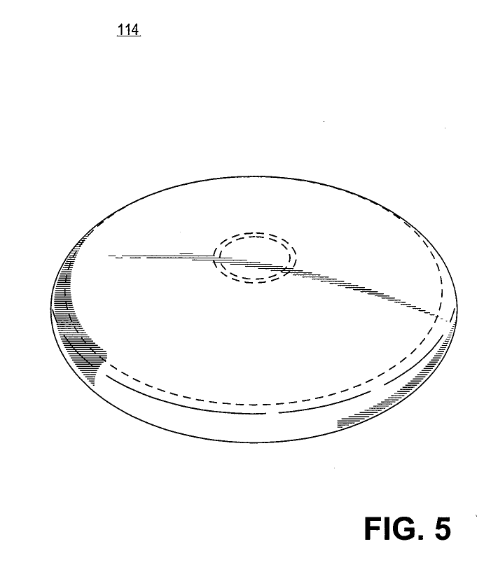

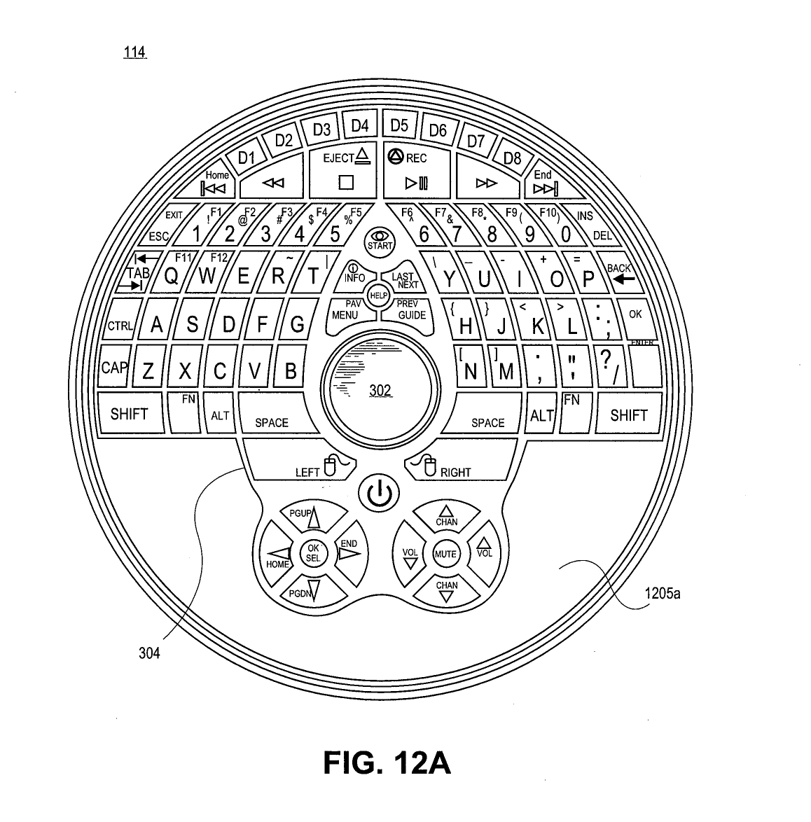

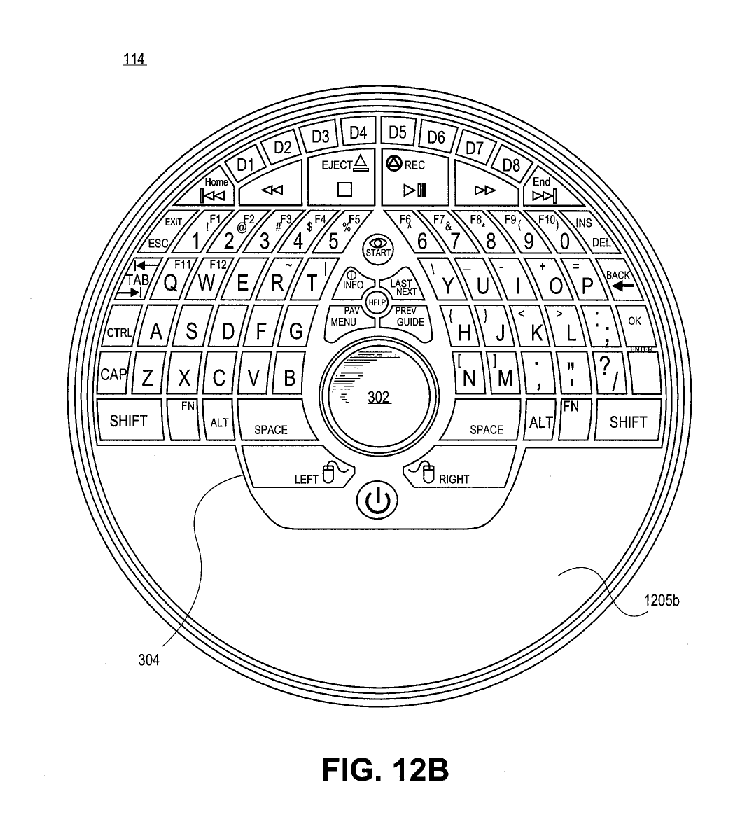

Referring now to FIGS. 5-11, examples of a remote control 114 with a saucer-shaped housing are shown. The saucer shaped housing may be circular in plan view and sized to be graspable by a user in one or two hands. The upper side of the saucer-shaped housing may be convexly shaped and in some embodiments may include soft button/screen area 302, hard button area 304, sensor area 306, and/or a keyboard including hard buttons 404 as shown in FIG. 12. The lower side of the saucer-shaped housing may be partially convex shaped and may include a depression (e.g., depression 715 as shown in FIG. 7). The depression may be sized and adapted to accommodate one or more fingers one or both hands of a user. The housing may be shaped so that when it is held by the user in one or two hands, at least some fingers of the user's hand(s) are disposed within the depression on the partially lower convex side of the housing and thumb(s) of the user's hands are located in proximity to the top surface of remote control 114 and, for example, soft button/screen area 302, hard button area 304, sensor area 306, and/or a keyboard as provided on the upper surface.

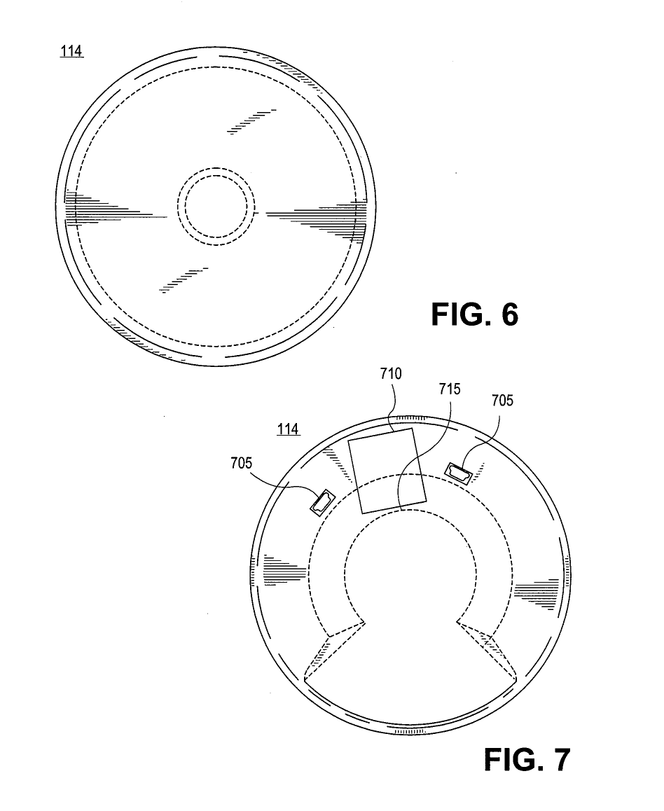

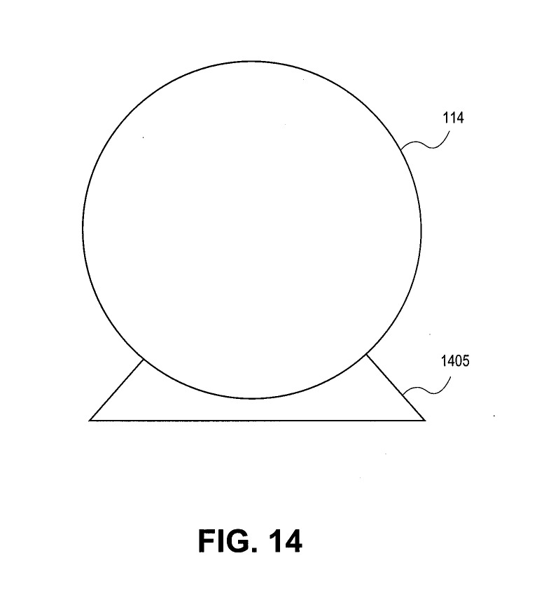

FIG. 6 is a top plan view of remote control 114. FIG. 7 is a bottom plan view of remote control 114 indicating the depression 715 and including a battery compartment 710 and two communication ports 705. Battery compartment 710 may be sized to hold, for example, a rechargeable battery or standard AA or AAA sized conventional or rechargeable batteries. Communication ports 705 may be coupled to communication interface 408 and may be compatible with, for example, a USB cable, a micro USB cable, a Fire Wire cable, an Ethernet cable, and the like. Communication ports 705 may be configured to communicatively couple with a corresponding cable or port coupled to, for example, set-top box 104 and/or included in, for example, a docking station, such as the docking station depicted in FIG. 14.

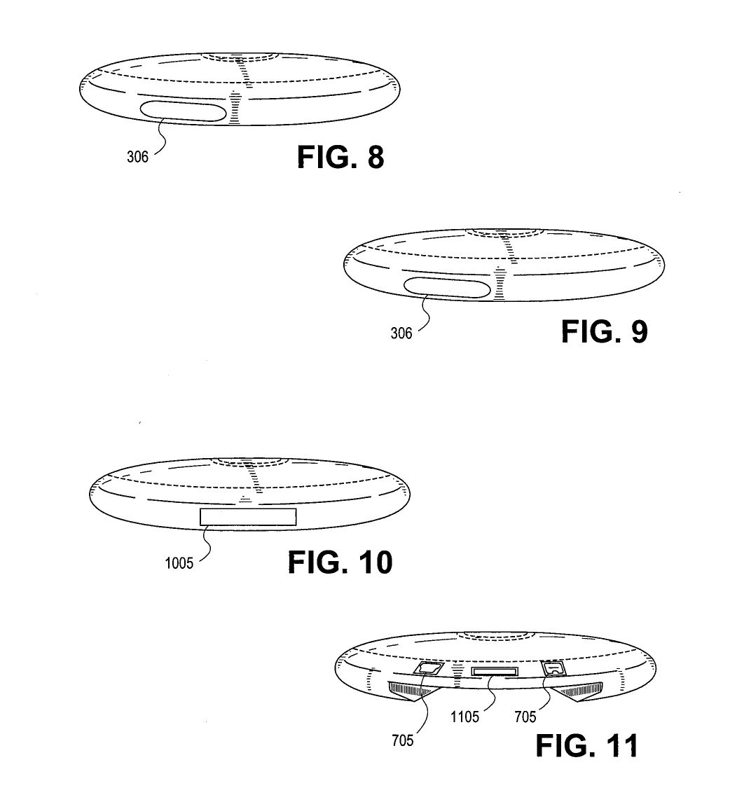

FIG. 8 is a right side elevation view of remote control 114 showing sensor area 306. FIG. 9 is a left side elevation view of remote control 114 showing sensor area 306. The locations of sensor areas 306 are shown on the left and right sides of remote control 114 of FIGS. 8 and 9, respectively, by way of example and not limitation. Sensor area 306 may be positioned in any location on or in remote control 114. For example, the bottom, top, sides, and/or entire casing of remote control 114 may act as sensor area 306.

FIG. 10 is a front elevation view of remote control 114 showing an aperture 1105 via which remote control 114 and/or communication interface 408 may communicate with an external device, such as set-top box 104. Aperture 1105 may be transparent to, for example, an infrared signal, an ultra-violet signal, an electromagnetic signal, a 2.4 gigahertz radio frequency signal, a Bluetooth signal, a ZigBee signal, a radio frequency for consumer electronics (RF4CE) signal, and/or a benign microwave signal.

FIG. 11 is a rear elevation view of remote control 114 showing a power recharging port 1105 and communication ports 705. Power recharging port 1105 may be configured to couple with a conventional electric power source, such as an electrical wall outlet or a battery and transfer electric power to power supply 410. Alternatively, or additionally, in another embodiment of the invention, a communication port 705 may be used, in place of power recharging port 1105, as the means for providing electrical power for operating the remote control and/or recharging any rechargeable battery within the remote control as would be possible with USB, for example.

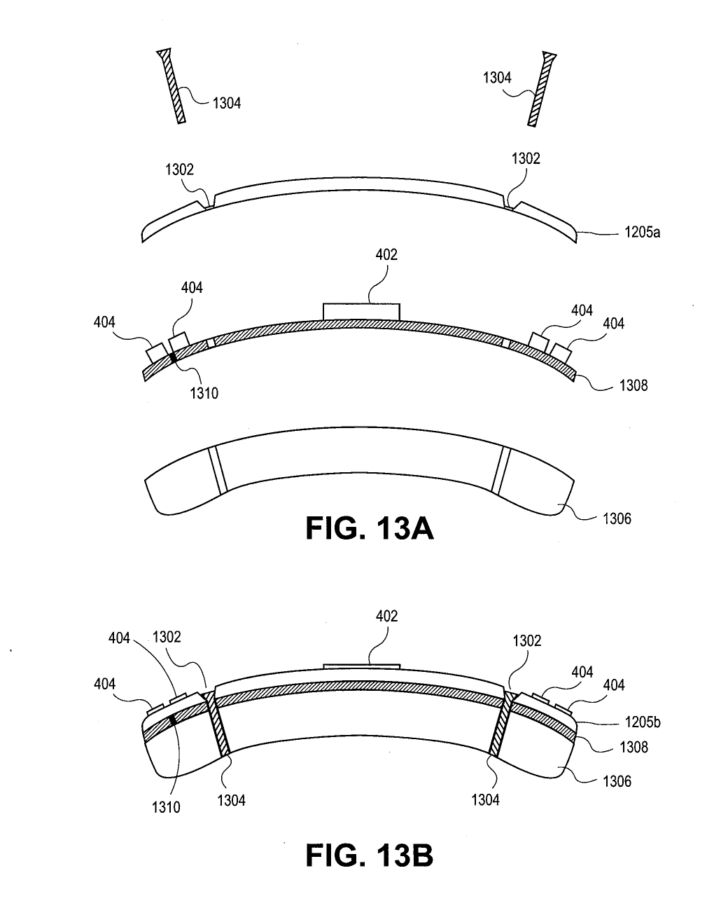

FIG. 12A is a top plan view of an exemplary remote control 114 showing an exemplary keyboard and removable faceplate arrangement. The remote control 114 of FIG. 12A includes a first removable faceplate 1205a, hard button area 304, and soft button/screen area 302. Hard buttons 404 and/or soft button/screens 402 may be arranged on and/or extend from a keypad membrane as discussed below with regard to FIGS. 13A and 13B. Removable faceplate 1205a may be configured to fit over the top surface of remote control 114 and may include openings through which one or more hard buttons 404 and/or soft button/screens 402 may extend. Removable faceplate 1205a may be manufactured from, for example, metal and/or plastic and may be available in a variety of colors and/or surface finishes. Exemplary hard buttons 404 may include, for example, selectable alphanumeric keys and control keys (e.g., play, stop, pause, fast forward, and mouse click buttons). Soft button/screen area 302 may include one or more screens (e.g., liquid crystal display screens) for implementing soft (e.g., programmable) buttons 402 and/or providing messages to a user. In some embodiments, soft button/screen area 302 may be a touchscreen or a trackpad (e.g., capacitive touchscreen) and may be responsive to a user's touch and/or gesture.

FIG. 12B is a top plan view of an exemplary remote control 114 showing an alternative exemplary keyboard and removable faceplate arrangement. The remote control 114 of FIG. 12B includes a second removable faceplate 1205b, hard button area 304, and soft button/screen area 302. Second removable faceplate 1205b illustrates a second alternative embodiment of a keyboard and removable faceplate arrangement with fewer functions than removable faceplate 1205a. Although only two examples of keyboard and removable faceplate arrangements are provided, many other alternative arrangements are possible. For example, keyboard and removable faceplate arrangements may be tailored to accommodate different languages, various levels of operational complexity, right-handedness, left-handedness, and/or personal preferences.

FIG. 13A is an exploded view of an exemplary remote control 114 showing a removable faceplate 1205a and/or 1205b, a fixture aperture 1302, a fixture mechanism 1304, a remote control base 1306, a keyboard membrane 1308, hard buttons 404, and soft button/screen 402. Keyboard membrane 1308 may support one or more hard buttons 404 and/or soft button/screens 402. The hard buttons 404 and/or soft button/screens 402 may extend from an upper surface of keyboard membrane 1308 through one or more openings in removable faceplate 1205a and/or 1205b tailored to accommodate a respective hard button 404 and/or soft button/screen 402. In this way, removable faceplate 1205a and/or 1205b and keyboard membrane 1308 may be designed to fit together such that hard buttons 404 and/or soft button/screens 402 extend upward from the surface of keyboard membrane 1308 through openings in the removable faceplate 1205a and/or 1205b so that the hard button 404 and/or soft button/screen 402 may be selected by a user by, for example, applying pressure to the hard button 404 and/or soft button/screen 402 via one or more fingers and/or thumbs.

Fixture mechanism 1304 may be any mechanism for affixing removable faceplate 1205a and/or 1205b and/or keyboard membrane 1308 to remote control 114, such as a screw, a pin, and a clip and may be inserted into fixture aperture 1302. By removing, or otherwise adjusting fixture mechanism 1304, removable faceplate 1205a and/or 1205b and/or keyboard membrane 1308 may be removed from the top of remote control 114. Likewise, by inserting, or otherwise adjusting fixture mechanism 1304, a removable faceplate 1205a and/or 1205b and/or keyboard membrane 1308 may be affixed to an upper surface of remote control 114. Although FIG. 13A shows insertion of fixture mechanism 1304 into an upper surface of removable faceplate 1205a and/or 1205b, a skilled artisan will recognize that fixture mechanism 1304 may operate from any position (e.g., from an underside of remote control 114) to remove and/or affix removable faceplate 1205a and/or 1205b and/or keyboard membrane 1308 to remote control 114. In some cases, a second removable faceplate 1205a and/or 1205b and/or a second keyboard 1308 may be affixed to remote control 114 following removal of a first removable faceplate 1205a and/or 1205b and/or keyboard membrane 1308.

Replacement of removable faceplate 1205a and/or 1205b and/or keyboard membrane 1308 may serve, for example, a cosmetic and/or functional purpose. For example, a second keyboard membrane 1308 may include one or more buttons different from buttons provided on a first keyboard membrane 1308 and second removable faceplate 1205a and/or 1205b may be specifically tailored to accommodate the buttons of the second keyboard membrane 1308.

Many embodiments of keyboard membrane and/or removable faceplate may be affixed to remote control 114. Exemplary keyboard membranes 1308 may include options for operating remote control 114 in various languages On some occasions, keyboard membrane 1308 includes an identification mechanism such as a On some occasions, the keypad membrane may further include an identification mechanism 1310, such as an ID tag, a bar code, a radio frequency identifier (RFID), and/or a microchip and the processor and/or communication interface may be configured to recognize the keypad membrane via the identification mechanism.

FIG. 13B is a collapsed side view of the exemplary remote control 114 depicted in FIG. 13A and illustrates one example of an assembled remote control 114 including removable faceplate 1205a and/or 1205b, fixture aperture 1302, fixture mechanism 1304, remote control base 1306, hard button area 304, soft button/screen area 302, hard buttons 404, and soft button/screen 402.

FIG. 14 illustrates remote control 114 positioned within an exemplary docking station 1405. Docking station 1405 may serve to physically support remote control 114, provide electrical power to remote control 114 via, for example, a power port 1105, and/or provide information and/or a set of instructions via a communication port, such as communication port 705. As noted above, in an alternative embodiment of the invention, the power port 1105 and the communication port 705 may be combined into a single port providing both power and communication.

Thus, a remote control with one or more sensors for determining user identity has been described. Note that although the present invention has been described herein in the context of a remote control, the same functionality may be provided in the set-top box or any device or combination of devices capable or executing the functions described herein. For example, fingerprint scanners could be provided on the set-top box and used in the fashion discussed above. Additionally, the set-top box may be equipped with a camera (or such an instrumentality may be communicatively coupled thereto by wired or wireless communication means), allowing the set-top box to perform user identification by means of facial, retinal or other visual identification means. Of course, the remote control may be configured to support such external sensors as well. That is, the sensors discussed herein need not be physically integrated into the remote control, but may instead be communicatively coupled thereto by wired or wireless means. Finally, in either instance, the entire sensor platform may be offloaded from the set-top box and the remote control and performed using a separate identification appliance having one or more biometric sensors. Such an appliance would operate at the direction of the set-top box or the remote control whenever a user was seeking to access a function which required user authentication before it was allowed. This may include access to restricted content items listed in an EPG or access to a user account.

What is claimed is:

1. A hand-held remote control, comprising:
a saucer-shaped housing, said housing being circular in plan view and sized to be graspable by a user in one or two hands with (i) a convex upper side that supports a keypad with a plurality of selectable buttons, and (ii) a partially convex lower side that includes a depression therein, said depression sized and adapted to accommodate one or more fingers of at least one hand of the user, whereby when the housing is held by the user in two hands, at least some fingers of the user's hands are disposed within the depression on the partially lower convex side of the housing and thumbs of the user's hands are located in proximity to the selectable buttons of the keypad;
a faceplate removably attached to the housing and adapted to maintain the keypad in contact with a portion of a surface of the upper side of the housing; and
disposed within the housing, a processor communicatively coupled to receive command inputs responsive to selection of one or more of the selectable buttons of the keypad and to communicate instructions to a communication interface communicatively coupled to the processor, the communication interface configured to respond to the instructions by transmitting one or more signals to an external device and receive a set of instructions from an external source.

2. The hand-held remote control device of claim 1, further comprising, disposed within the housing, a biometric sensor coupled to the processor and configured to receive biometric information from a user of the hand-held remote control device and communicate the received biometric information to the processor, wherein the processor is further configured to recognize the user based on the received biometric information and enable a recognized user to access viewing control options provided via the hand-held remote control device.

3. The hand-held remote control device of claim 2, wherein the biometric sensor is at least one of an optical scanner, a fingerprint scanner, a retinal scanner, a face recognition scanner, a DNA scanner, a voice scanner, an electromagnetic signal receiver, and a microphone.

4. The hand-held remote control device of claim 2, wherein the hand-held remote control device is further configured to communicate the received biometric information to a set-top box and receive verification of a user's identity via the set-top box.

5. The hand-held remote control device of claim 1, wherein the communication interface comprises a transceiver configured to wirelessly communicate with an external device via at least one of an electromagnetic signal, a 2.4 gigahertz radio frequency signal, an infrared signal, a Bluetooth signal, a ZigBee signal, a radio frequency for consumer electronics (RF4CE) signal, and a benign microwave signal.

6. The hand-held remote control device of claim 1, further comprising, disposed within the housing, a memory configured to store one or more sets of instructions executable by the processor and receive one or more sets of instructions via the communication interface.

7. The hand-held remote control device of claim 1, further including:
disposed within the housing, a rechargeable power source configured to recharge via a coupling with a power source provided in a docking station; and
disposed within the housing, a port configured to exchange information with the docking station.

8. The hand-held remote control device of claim 1, further comprising, disposed within the housing, a motion sensor configured to detect motion of the hand-held device in one or more directions.

9. The hand-held remote control device of claim 1, wherein the communication interface comprises a port compatible with at least one of a universal serial bus (USB) cable, a micro USB cable, a firewire cable, and an Ethernet cable.

10. The hand-held remote control device of claim 1, wherein the removable faceplate includes openings adapted to accommodate the selectable buttons and the keypad comprises a removable keypad membrane positioned beneath the removable faceplate, the selectable buttons extending therefrom through the openings in the faceplate

11. The hand-held remote control device of claim 1, wherein the keypad membrane further includes an identification mechanism and the processor is configured to recognize the keypad membrane via the identification mechanism.

12. A system comprising:
a hand-held remote control device including:
a saucer-shaped housing, said housing being circular in plan view and sized to be graspable by a user in one or two hands with (i) a convex upper side that supports a keypad with a plurality of selectable buttons, and (ii) a partially convex lower side that includes a depression therein, said depression sized and adapted to accommodate one or more fingers of at least one hand of the user, whereby when the housing is held by the user in two hands, at least some fingers of the user's hands are disposed within the depression on the partially lower convex side of the housing and thumbs of the user's hands are located in proximity to the selectable buttons of the keypad;
a faceplate removably attached to the housing and adapted to maintain the keypad in contact with a portion of a surface of the upper side of the housing; and
disposed within the housing, a processor communicatively coupled to receive command inputs responsive to selection of one or more of the selectable buttons of the keypad and to communicate instructions to a communication interface communicatively coupled to the processor, the communication interface configured to respond to the instructions by transmitting one or more signals to a set-top box;
the set-top box adapted to receive signals from the communication interface of the hand-held remote control device and configured to provide information for display to the user on a display device; and
the display device communicatively coupled to the set-top box and configured to display the information provided by the set-top box to the user.

13. The system of claim 12, wherein the hand-held remote control device further comprises, disposed within the housing, a biometric sensor coupled to the processor and configured to receive biometric information from a user of the hand-held remote control device, recognize the user based on the received biometric information, enable a recognized user to control viewing options provided to the recognized user via the set-top box, and enable the recognized user to customize at least one of a function associated with the hand-held remote control device and information available for display to the user via the set-top box.

14. The system of claim 12, further comprising a server communicatively coupled to receive biometric information regarding the user of the hand-held remote control device via the at least one of the hand-held remote control device and the set-top box, analyze the received biometric information in order to verify the user's identity, and communicate verification of the user's identity to the at least one of the hand-held remote control device and the set-top box.

15. The system of claim 14, wherein the hand-held remote control device is configured to provide user-customized viewing control options upon receipt of verification of the user's identity.
